(19) United States
(12) Patent Application Publication
(10) Pub. No.: US 2003/0028848 A1
(43) Pub. Date: Feb. 6, 2003

(54) System for viewing multimedia presentations

(76) Inventor: Gerald Choi, Stouffville (CA)

Correspondence Address: GERALD CHOI, 3134 BLOOMINGTON RD., STOUFFVILLE, ON, L4A 7X5, CA

(21) Appl. No.: 10/200,171

(22) Filed: Jul. 23, 2002

(30) Foreign Application Priority Data
Aug. 1, 2001 (CA) 2,355,401

(51) Int. Cl. G06F 15/00

(52) U.S. Cl. 715/500.1

(57) ABSTRACT

A system for co-ordinating the display of a multimedia tour in a selected geographical area comprises a display and an interface for receiving user input to monitor selected display characteristics of the tour. The system includes at least two media types retrievable from a storage medium for presentation on the display. A map of the selected geographical area is provided for presentation on the display. The system includes a marker for indicating a position on the map, and the marker is adapted for relative displacement with respect to the map. The system provides an inter-relater for synchronising the relative displacement between the map and the marker with the playback of the at least two media types on the display. The playback is performed according to the selected display characteristics of the tour.

### BACKGROUND OF THE INVENTION

1. FIELD OF THE INVENTION

The present invention relates to multimedia presentation playback on a display.

2. DESCRIPTION OF THE PRIOR ART

Potential purchasers of real estate are often interested in researching the neighbourhood where property is located. Housing and condominium developers are therefore interested in providing their potential and current clients with information about the amenities available near their developments. A typical advertisement for a house or an apartment may include information that a school is nearby, or that there is nightlife in the area. Some consumers may use such well-known tools as maps and telephone books to determine businesses and amenities in a certain area. However, such methods do not generally provide an appreciation of the relative locations of amenities, and their distances from each other. Many consumers will go through a process of cross-referencing a telephone book to a map in an attempt to determine the restaurants and bars that are nearby.

Some websites provide limited information about the neighbourhoods around commercial developments. However, this information is usually limited to the existence and distance to certain amenities and does not give a sense of the neighbourhood. Further, the information in each website is separate, and thus requires switching among the multiple websites to assemble and fully understand the neighbourhood and commercial information.

It is an object of the present invention to provide a multimedia presentation which obviates or mitigates at least some of the above disadvantages.

### SUMMARY OF THE INVENTION

In general terms, the inventor has developed a method of linking and synchronising various types of media to produce a presentation with comprehensive information including multiple views and a walk through. The method provides an integrated presentation with coordinated display of the media.

In accordance with one aspect of the present invention there is provided a system for coordinating the display of a multimedia tour in a selected geographical area. The system comprises:

a) a display;

b) an interface for receiving user input to monitor selected display characteristics of the tour;

c) at least two media types retrievable from a storage medium for presentation on the display;

d) a map of the selected geographical area for presentation on the display;

e) a marker for indicating a position on the map, the marker adapted for relative displacement with respect to the map;

f) an inter-relater for synchronising the relative displacement between the map and the marker with the playback of the at least two media types on the display, the playback being performed according to the selected display characteristics of the tour.

In accordance with another aspect of the present invention, there is provided a computer program product for co-ordinating the display of a multimedia tour in a selected geographical area. The product comprises:

a) a computer readable medium;

b) an interface module stored on the medium for receiving user input to monitor selected display characteristics of the tour;

c) a media module stored on the medium for presenting at least two media types on the display;

d) a map module stored on the medium for presenting a map of the selected geographical area on the display;

e) a marker module coupled to the map module for indicating a position on the map with a marker, the marker adapted for relative displacement with respect to the map;

f) an inter-relater module stored on the medium synchronising the relative displacement between the map and the marker with the playback of the at least two media types on the display, the playback being performed according to the selected display characteristics of the tour.

In accordance with a further aspect of the present invention, there is provided a method for coordinating the display of a multimedia tour in a selected geographical area. The method comprises:

a) receiving user input to monitor selected display characteristics of the tour;

b) presenting at least two media types on the display;

c) presenting a map of the selected geographical area on the display;

d) indicating a position on the map with a marker, the marker adapted for relative displacement with respect to the map;

e) synchronising the relative displacement between the map and the marker with playback of the at least two media types on the display, the playback being performed according to the selected display characteristics of the tour.

### BRIEF DESCRIPTION OF THE DRAWINGS

These and other features of the preferred embodiments of the invention will become more apparent by way of example only in the following detailed description in which reference is made to the appended drawings wherein:

FIG. 1 shows components of a viewer;

FIG. 2 is a screen display of the viewer of FIG. 1;

FIG. 3 is an example map on the display of FIG. 2;

FIG. 4 is an example navigation on the display of FIG. 2;

FIG. 5 is a time line used by the system of FIG. 1;

FIGS. 5a, 5b, 5c, and 5d are views similar to FIG. 3 using the time line of FIG. 5;

FIG. 6 is a flow chart implementing the time line of FIG. 5; and

FIG. 7 is a further embodiment of the flow chart of FIG. 6;

### DESCRIPTION OF THE PREFERRED EMBODIMENTS

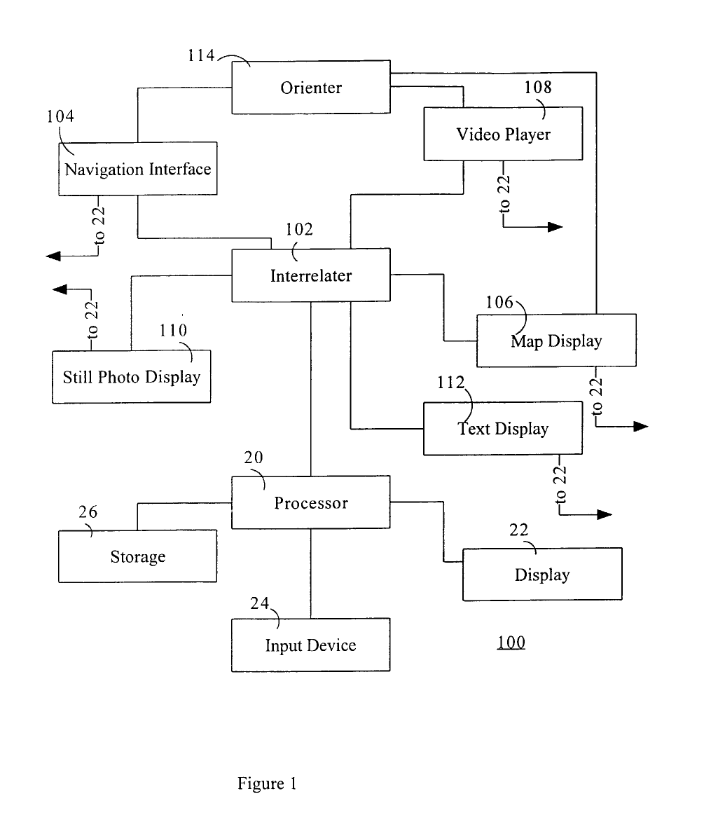

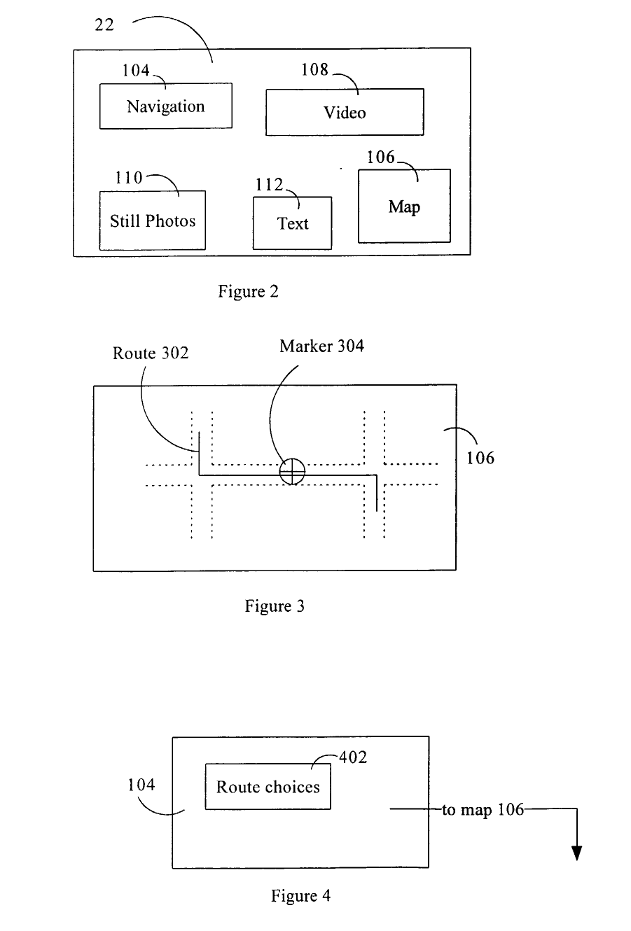

Referring to FIGS. 1 and 2, a system 100 for multimedia presentations comprises a processor 20 which controls a navigation interface 104, a map display 106 and a video player 108. The processor 20 implements an inter-relater 102 which co-ordinates the navigation interface 104, the map display 106, and the video player 108. The processor 20 further controls a photo display 110 for still photos of milestones such as restaurants and stores, and a text display 112 for providing the names of the milestones to a user of the system 100. The multimedia data for the map display 106, video player 108, photo display 110, and text display 112 can be retrieved from a computer readable storage medium 26. Accordingly, the inter-relater 102 provides synchronous playback of video on the video play 108 and display of a map on the map display 106. The playback is co-ordinated with display of still photos of the milestone on the photo display 110, and text describing the milestone on the text display 112 to provide a multimedia tour as selected by the user.

The processor 20 is coupled to a display screen 22 and to user input devices 24, such as a keyboard, mouse, or other suitable devices. If the display screen 22 is touch sensitive, then the display screen 22 itself can be employed as the user input device 24. The computer readable storage medium 26 is coupled to the processor 20 for providing instructions to the processor 20 to instruct and/or configure the inter-relater 102, as further explained below. The computer readable medium 26 can include hardware and/or software such as, by way of example only, magnetic disks, magnetic tape, optically readable medium such as CD-ROMs, and semiconductor memory such as PCMCIA cards. In each case, the medium 26 may take the form of a portable item such as a small disk, floppy diskette, cassette, or it may take the form of a relatively large or immobile item such as hard disk drive, solid state memory card, or RAM. It should be noted that the above listed example medium 26 could be used either alone or in combination with other storage media.

The navigation interface 104, the map 106, and the video player 108 are connected to an orienter 114. The display screen 22 as shown in FIG. 2 contains a display of each of the navigation interface 104, the map display 106, the video player 108, the photo display 110, and the text display 112. The navigation interface 104 presents the user with choices to control the multimedia presentation along a route in a geographical area. The map display 106 presents the user with a map of a portion of the geographical area. The map display 106 also uses a marker 304 to show the position of the presentation along the route. The video player 108 presents a video playback along the route. The photo display 110 presents photos of milestones along the route. The text display 112 presents text relating to the milestones along the route. In use, the inter-relater 102 controls the operation of the navigation interface 104, the map display 106, and the video player 108 for synchronised play back, which interrelates the display of each of the media. The inter-relater also controls the photo display 110 and text display 112, using them to display the photos and text at the milestones along the route display. In one example of synchronised playback, the video displayed by the video player 108 shows video of the same position as the marker 304 in the map display 106. As the presentation is displayed, the video moves along the route and the marker 304 indicates the changing position. As milestones are shown in the video displayed by the video player 108, the photo display 110 and the text display 112 show photos and text, respectively, relating to the milestone. The orienter 114 keeps track of a direction of travel and co-operates with the navigation interface 104, the map display 106 and the video 108 for co-ordinated play back.

During use, the display screen 22 presents the multimedia tour to the user. The navigation interface 104 presents options on routes and allows the user to choose milestones of interest through the input device 24. Choosing a route from the navigation interface 104 begins the multimedia tour at a starting point determined by the route. During the tour, the video player 108 plays pre-recorded video along the chosen route. Other visual media may be embedded into the video playback. One such type of visual media is a 3D animated object. The map 106 displays the current position of the video playback through the marker 304. At certain milestones along the route, the still photo display 110 and text display 112 show information corresponding to the milestone. Audio commentary is also played in synchronisation with the video playback provided by the video player 108 and the map provided by the map display 106.

The video player 108 shows pre-recorded video of a particular route in the geographical area. During recording, the camera moves in a particular direction of travel. This direction of travel is used by the orienter 114 to co-ordinate the presentation. Still photos and corresponding text descriptions are associated with milestones along the route. The order in which the photos and text are displayed is determined by the direction of travel provided by the orienter. The orienter 114 interacts with the map 106 to co-ordinate the direction of travel in the video playback with animation of the map 106.

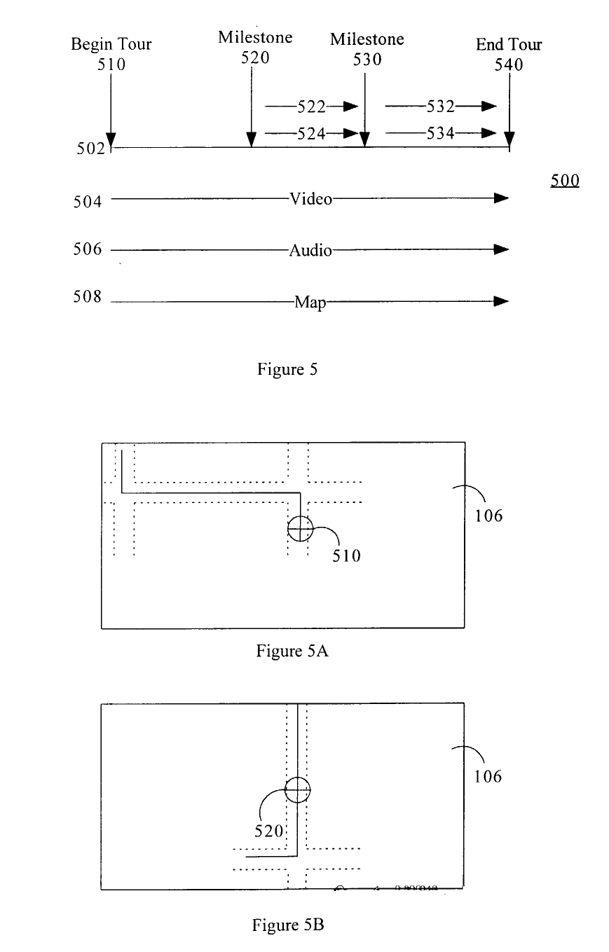

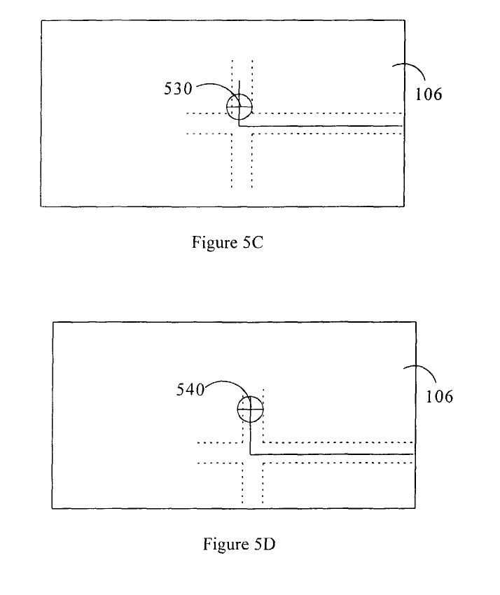

Referring to FIG. 3, a particular display of the map 106 is shown in more detail. The map contains a route of travel 302, and a marker 304 showing the current position. The map also displays a number of streets and routes. The marker 304 is placed generally in the centre of the map 106, that is in a fixed position. The map display 106 moves and turns under the fixed marker 304 during a presentation in the direction of travel directed by the orienter 114. It is also recognised that the marker 304 could also move relative to a stationary map shown on the map display 106. Accordingly, the map shown by the map display 106 on the display screen 22 continuously changes during the presentation in synchronisation with the other media. In other words, the media display information about the same location. For example, the photo display 110 and text display 112 show detailed information about a particular milestone along the tour. The map display 106 shows the location of the milestone. As the presentation moves from milestone to milestone, the video played by the video player 108 shows the locations passed between milestones. Thus when each milestone is reached, the video played by the video play 108 on the display screen 22 shows the immediate area of the milestone. The photo display 110 and text display 112 continue to show information about the milestone until the route approaches another milestone. During a particular presentation, the map display 106 will display the route 302. Movement of the map displayed by the map display 106 behind the marker 304 shows movement along the route 302, as further set forth below with reference to FIGS. 5a, 5b, 5c and 5d.

Referring to FIG. 4, the navigation interface 104 is shown in more detail. The navigation comprises a number of route choices 402, which trigger corresponding displays on the map display 106. Each route choice 402 thus produces a corresponding route 302 in the map display 106. A navigation interface 104 operates under the control of the user through the input device 24. The navigation interface 104 allows the end user to change the tour parameters, such as, but not limited to, geographical area, beginning of the tour, end of the tour, direction of the tour, milestones of interest (e.g. restaurants, stores, bars, clubs), speed of the tour, and route. It also provides functions such as skip, stop, pause, as well as links to major areas of interest. The user may thus choose a route of interest using the input device 24 and the navigation interface 104. The inter-relater 102 will then play the appropriate presentation in the direction of travel provided by the orienter 114. During the presentation, the user may stop the presentation on the display screen 22 using the navigation interface 104, or skip to an area of particular interest on the map 106, an expanded overview map, or a list of locations. The user may also change the route being displayed on the display screen 22 using the navigation interface 104. Furthermore, the navigation interface 104 may allow the user to navigate through the geographic area using the map alone, as displayed on the map display 106. In this case, the user chooses tour parameters by first selecting a starting point for the tour, and then selecting an ending point for the tour. A navigation interface 104 then directs the inter-relater 108 to display on the display screen 22 an appropriate route from the user's chosen start point to the user's chosen ending point.

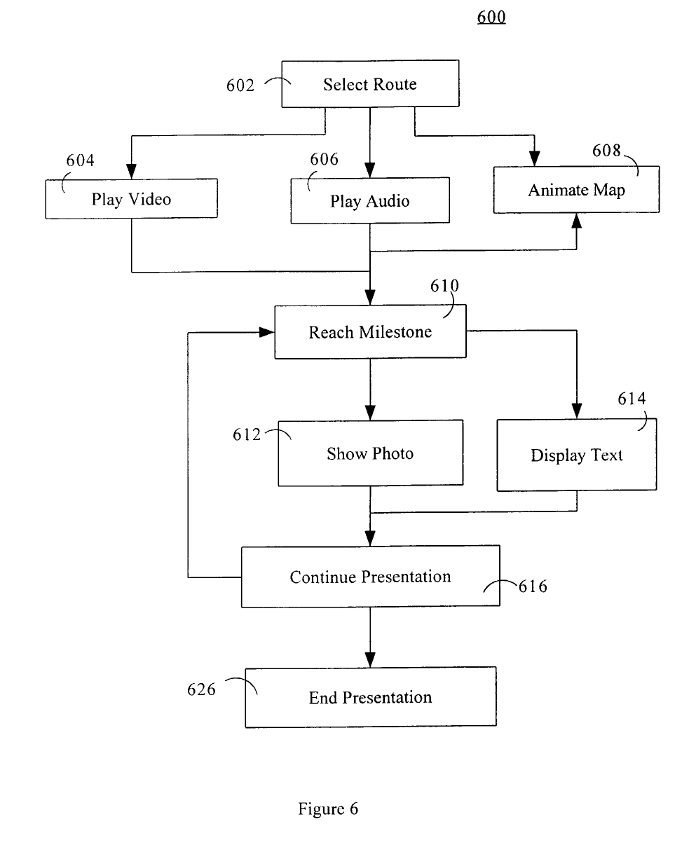

Referring to FIGS. 5, 5a, 5b, 5c, 5d, and 6, the operation of the system 100 is shown in more detail by the numerals 500 and 600. Referring particularly to FIG. 5, the time line of events is shown. The beginning of the tour is shown as 510, and the tour passes through milestones 520 and 530 before ending at the location designated by the numeral 540. Examples of milestones 520, 530 are such as, but not limited to restaurants, stores, schools, banks, clubs, and bookstores. As time passes along line 502, the video playback 504, audio playback 506, and the map display 508 are outputted on the display screen 22, or in the case of audio through an audio device such as, but not limited to, speakers or headphones. The display of the three media chosen (video, audio, and the map) is synchronised by the inter-relater 102. The orienter 114 controls the direction of travel, so that the map shown by the map display 106 on the display screen 22 moves in the same direction as the video shown by the video player 108 on the display screen 22. The audio provided by an audio player is also synchronised with the display on the display screen 22 to provide appropriate commentary along the tour.

The tour begins at milestone 510 as shown in FIG. 5a. The marker 304 indicates the milestone 510 as the current location. It will be recognised that some streets may not fit in the display screen 22 due to animation of the map. At milestone 520, the map is as shown in FIG. 5b with the centre of the map at milestone 520. Arrival at milestone 520 triggers the photo display 110 to show a picture 522 corresponding to the milestone 520, and the text display 112 to show text 524 corresponding to the milestone 520. The photo 522 and the text 524 corresponding to milestone 520 are shown until the tour reaches milestone 530. Upon reaching milestone 530, a photo 532 of milestone 530 and a text description 534 of milestone 530 replace photo 522 and text 524. The map is as shown in FIG. 5c, with milestone 530 at the centre of the map. The tour ends at the endpoint 540, with a map as shown in FIG. 5d. Between the milestones, the map is continuously animated. The video played by the video player 108 shows the progression of the tour between milestones.

The tour begins by selecting (602) a route. The inter-relater 102 then plays (604) video, plays (606) audio, and animates (608) the map. The play back of the audio by the audio player, video by the video player 108 and map by the map display 106 are synchronised by the inter-relater 102. The playback of the video by the video player 108 shows the geographical area along the route between milestones. When the presentation reaches (610) milestone 520, the inter-relater 102 then shows (612) photo 522 and displays (614) text 524, both corresponding to the milestone 520. The presentation then continues (616), with the display showing the continuing video, audio and map as well as the photo 522 and the text 524. The video shows the area between milestone 520 and milestone 530 in synchronisation with the movement between the marker 304 and the map on the map display 106. Upon reaching (610) milestone 530, photo 532 and text 534 are shown (612, 614). The presentation then continues (616) with display of video, audio and animation of the map. The tour ends (626) upon reaching the endpoint 540.

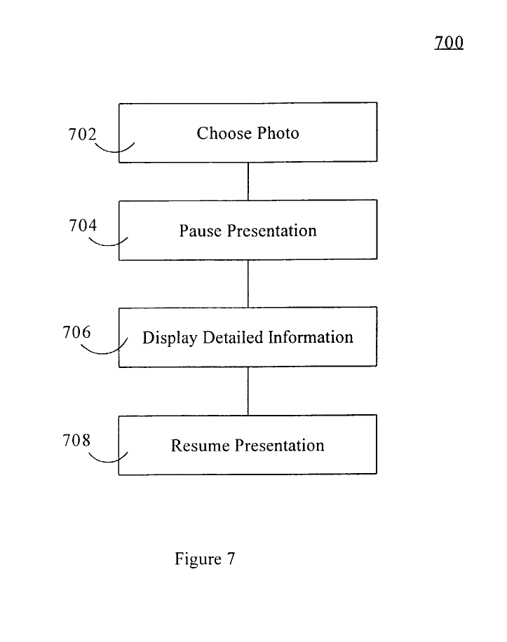

During play back of the presentation, the user may click or otherwise interact with a photo to obtain further information. Referring to FIG. 7, the sequence of events upon choosing (702) photo 522 is shown. The presentation is paused (704), and detailed information about photo 522 is shown (706). The user may then review the information at their leisure. When the user closes the detailed information window, the presentation resumes (708). Spacing the milestones 520, 530 along the route allows time for the user to consider the photo and text and decide whether to view more information. Alternatively, a pause function may be triggered by the user to allow time to consider the photo and text, and decide whether to view more information on the milestone.

It will be recognised that in the operation shown in FIGS. 5 and 6, that any number of milestones may be used. The embodiment above shows two milestones, and accordingly, steps 612 and 614 are performed twice. With more milestones, milestones are consecutively reached at step 610, and steps 612 and 614 are performed for each milestone. The presentation ends at step 626 after all milestones have been visited and the end of the tour is reached.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A system for co-ordinating the display of a multimedia tour in a selected geographical area, the system comprising:
a) a display;
b) an interface for receiving user input to monitor selected display characteristics of the tour;
c) at least two media types retrievable from a storage medium for presentation on said display;
d) a map of said selected geographical area for presentation on said display;
e) a marker for indicating a position on said map, the marker adapted for relative displacement with respect to said map;
f) an inter-relater for synchronising said relative displacement between said map and said marker with the playback of said at least two media types on said display, the playback being performed according to said selected display characteristics of said tour.

2. A system according to claim 1, wherein said interface provides at least one predetermined route for said tour.

3. A system according to claim 1, wherein said interface provides a pause function.

4. A system according to claim 3, wherein said interface provides a detail function to activate said pause function and provide information about a milestone.

5. A system according to claim 1, further comprising an orienter for co-ordinating said relative displacement of said marker and said map in a direction provided by at least one of said media.

6. A computer program product for co-ordinating the display of a multimedia tour in a selected geographical area, the product comprising:
a) a computer readable medium;
b) an interface module stored on the medium for receiving user input to monitor selected display characteristics of the tour;
c) a media module stored on the medium for presenting at least two media types on said display;
d) a map module stored on the medium for presenting a map of said selected geographical area on said display;
e) a marker module coupled to said map module for indicating a position on said map with a marker, the marker adapted for relative displacement with respect to said map;
f) an inter-relater module stored on the medium for synchronising said relative displacement between said map and said marker with the playback of said at least two media types on said display, the playback being performed according to said selected display characteristics of said tour.

7. A computer program product according to claim 6, wherein said interface module provides at least one predetermined route for said tour.

8. A computer program product according to claim 6, wherein said interface module provides a pause function.

9. A computer program product according to claim 8, wherein said interface module provides a detail function to activate said pause function and provide information about a milestone.

10. A computer program product according to claim 6, further comprising an orienter module stored on the medium co-ordinating said relative displacement of said marker and said map in a direction provided by at least one of said media;

11. A method of co-ordinating the display of a multimedia tour in a selected geographical area, the method comprising the steps of:
a) receiving user input to monitor a selected display characteristic of the tour;
b) presenting at least two media types on a display;
c) presenting a map of said selected geographical area on said display;
d) indicating a position on said map with a marker, the marker adapted for relative displacement with respect to said map;
e) synchronising said relative displacement between said map and said marker with the playback of said at least two media types on said display, the playback being performed according to said selected display characteristics of said tour.

12. A method according to claim 1 1, further comprising the step of providing at least one predetermined route for said tour.

13. A method according to claim 12, further comprising the step of choosing a route from said at least one predetermined route in response to said user input.

14. A method according to claim 13, further comprising the step of displaying the photos of milestones along said route.

15. A method according to claim 14, further comprising the step of displaying text relating to said milestones.

16. A method according to claim 1 1, further comprising the step of pausing said presentation in response to said user input.

17. A method according to claim 11, further comprising the step of displaying detailed information on a milestone in response to said user input.

18. A method according to claim 11, further comprising the step of co-ordinating said relative displacement of said marker and said map in a direction provided by at least one of said media.

19. A method according to claim 11, further comprising the step of playing audio in synchronisation with said tour.

20. A method according to claim 11, further comprising the step of animating said map to effect said relative displacement.
